(19) United States
(12) Patent Application Publication
(10) Pub. No.: US 2006/0007412 A1
(43) Pub. Date: Jan. 12, 2006

(54) Light emitting apparatus and image projection apparatus

(75) Inventor: Katsunori Kumai, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/118,677

(22) Filed: Apr. 29, 2005

(30) Foreign Application Priority Data
Jul. 9, 2004 (JP) 2004-203113

(51) Int. Cl. G03B 21/14

(52) U.S. Cl. 353/119

(57) ABSTRACT

A light emitting apparatus has a light source unit having a light source portion which is arranged on a circumference of a circle, and emits light, a light leading unit which has a light entering end into which the light emitted by the light source unit is entered, and a light emitting end from which the light, which is sent from the light entering end and is reflected by an inner surface, is emitted, a driving unit for rotating the light leading unit around a rotation axis which passes through a center of the circumference of the circle, and is made orthogonal to a surface including the circumference of the circle, and a cover portion which covers at least a part of the light leading unit, and decreases a reaction which is given from a surrounding atmosphere according to a rotation of the light leading unit.

### BACKGROUND OF THE INVENTION

1. Field of the Invention

The present invention relates to a light emitting apparatus and to an image projection apparatus.

Priority is claimed on Japanese Patent Application No. 2004-203113, filed Jul. 9, 2004, the content of which is incorporated herein by reference.

2. Description of Related Art

Generally, a discharge type of lamp is used as a light source unit of a light emitting apparatus in an image projection apparatus, such as a projector. However, because such light emitting apparatuses have increased in size, in recent years, a light emitting apparatus is proposed in which a plurality of light emitting diodes (LEDs) are arranged on a circumference of a circle toward a center, and a light leading unit for NA transformation with a column-shape is rotated within the circumference of the circle, while the corresponding LEDs are successively emitted, and the condensing of the light is performed by the light leading unit (for example, Patent Document 1: Japanese Unexamined Patent Application, First Publication No. 2004-102132).

### SUMMARY OF THE INVENTION

A object of the present invention is to provide a light emitting apparatus and an image projection apparatus in which a starting time until reaching a predetermined number of rotations is shortened, while power consumption at the time of regular rotation can be reduced.

The present invention adopts the following means.

A light emitting apparatus according to the present invention has a light source unit having a light source portion which is arranged on a circumference of a circle, and emits a light, a light leading unit which has a light entering end into which the light emitted by the light source unit is entered, and a light emitting end from which the light, which is sent from the light entering end and is reflected by an inner surface, is emitted, a driving unit for rotating the light leading unit around a rotation axis which passes through a center of the circumference of the circle, and is made orthogonal to a surface including the circumference of the circle, and a cover portion which covers at least a part of the light leading unit, and decreases a reaction which is given from a surrounding atmosphere according to a rotation of the light leading unit.

Moreover, in the light emitting apparatus according to the present invention, a surface of the cover portion has a shape by which the reaction is decreased, compared with a surface of the light leading unit, and the cover portion may be rotated with the light leading unit.

Moreover, in the light emitting apparatus according to the present invention, the light leading unit may be supported by the cover portion.

Moreover, in the light emitting apparatus according to the present invention, the cover portion may be connected to the light source unit.

Moreover, in the light emitting apparatus according to the present invention, the cover portion and the light leading unit may be adjacent to each other with a gap.

Moreover, in the light emitting apparatus according to the present invention, a plurality of light entering ends of the light leading unit may be arranged at position which is rotationally symmetrical with each other with regard to the rotation axis, and the light emitting end of the light leading unit may be arranged near the rotation axis.

Moreover, in the light emitting apparatus according to the present invention, one light entering end of the light leading unit may be arranged, and balance weight of the light leading unit may be arranged at position which is rotationally symmetrical to the light entering end with regard to the rotation axis.

Moreover, in the light emitting apparatus according to the present invention, the driving unit rotates the light leading unit until the light leading unit reaches a predetermined number of rotations while accelerating the light leading unit, a value of integrating and adding an acceleration of the light leading unit which increases by the decrementing of the reaction may be larger than a value of integrating and adding an acceleration of the light leading unit which decreases by the moment of inertia of the cover portion during a time from a start to reaching the predetermined number of rotations.

Moreover, in the light emitting apparatus according to the present invention, at least one part of a plurality of convex portions and a plurality of recess portions may be arranged on a surface of the cover portion.

An image projection apparatus according to the present invention projects an image based on an inputted data using the above-mentioned light emitting apparatus, and has a space modulation unit which modulates the light emitted from the light emitting end of the light leading unit based on the inputted data, and a projection optical unit which projects the light modulated by the space modulation unit.

### BRIEF DESCRIPTION OF THE DRAWINGS

FIG. 1 is a schematic view which shows a system configuration of a projector according to a first embodiment of the present invention.

FIG. 2 is a perspective view which shows a light emitting apparatus according to the first embodiment of the present invention.

FIG. 3 is an exploded view which shows a configuration of the light emitting apparatus according to the first embodiment of the present invention.

FIG. 4 is a graphical view which shows a state comparing a relation ship between the predetermined number of the rotations of the light emitting apparatus according to the first embodiment of the present invention and a time for reaching the number of rotations thereof with the conventional case.

FIG. 5 is a graphical view which shows a state comparing a relation ship between a change of an electrical current required for rotation motor of the light emitting apparatus according to the first embodiment of the present invention and the time for reaching a steady state with the conventional case.

FIG. 6 is a perspective view which shows the light emitting apparatus according to the second embodiment of the present invention.

FIG. 7 is a perspective view which shows the light emitting apparatus according to the third embodiment of the present invention.

FIG. 8 is an exploded view which shows a configuration of the light emitting apparatus according to the third embodiment of the present invention.

FIG. 9 is a cross-sectional view which shows a configuration of the light emitting apparatus according to the fourth embodiment of the present invention.

FIG. 10 is a cross-sectional view which shows a configuration of the light emitting apparatus according to the fifth embodiment of the present invention.

FIG. 11A is a perspective view which shows the light emitting apparatus according to the sixth embodiment of the present invention.

FIG. 11B is a view which shows a second cover of the light emitting apparatus according to the sixth embodiment of the present invention.

### DETAILED DESCRIPTION OF THE INVENTION

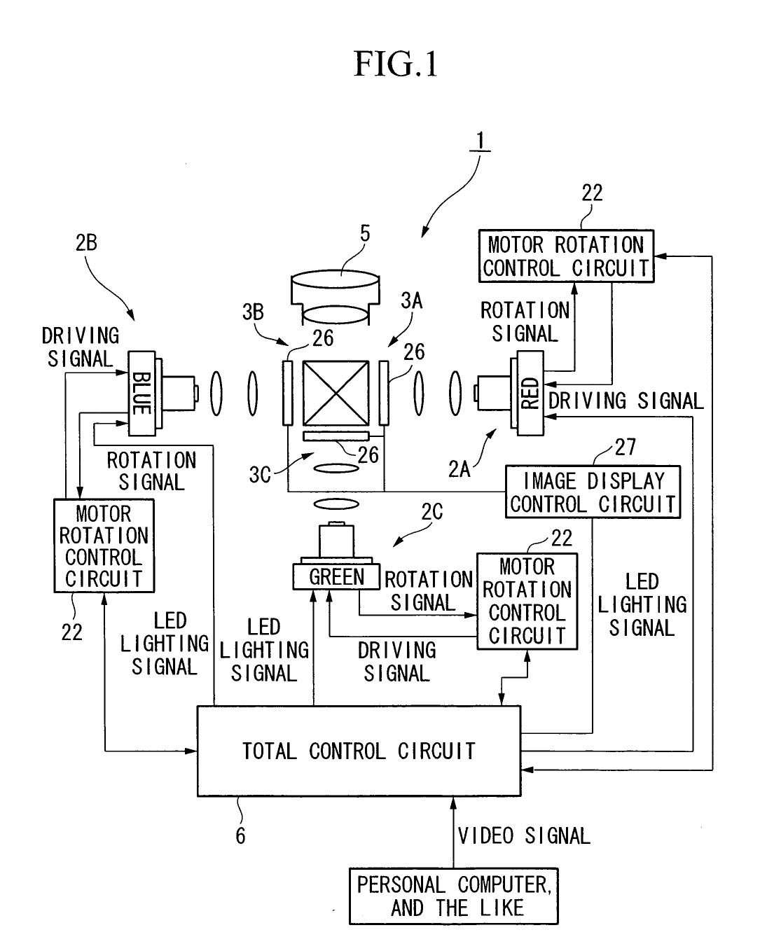

A first embodiment according to the present invention is explained with reference to FIG. 1 to FIG. 5.

A projector (an image projection apparatus) 1 according to the present embodiment is an image projection apparatus which projects an image based on data such as an image signal inputted from a personal computer, or the like, and, as shown in FIG. 1, is provided with light emitting apparatuses 2A, 2B, and 2C which emit a red light, a blue light, and a green light, respectively, space modulation units 3A, 3B, and 3C which modulate the light emitted by the light emitting apparatuses 2A, 2B, and 2C based on the inputted data, respectively, a projection lens (a projection optical unit) 5 which projects the light modulated by each space modulation unit 3A, 3B, and 3C, and a total control circuit 6 which controls the above components. In addition, because configurations of light emitting apparatuses 2A, 2B, and 2C or configurations of space modulation units 3A, 3B, and 3C are the same at each other, respectively, thereinafter, the light emitting apparatus 2A and the space modulation unit 3A are explained.

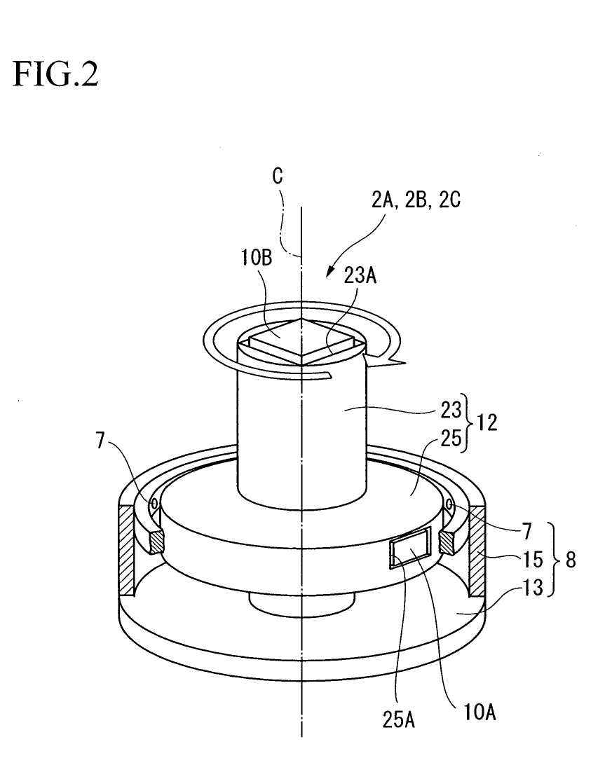

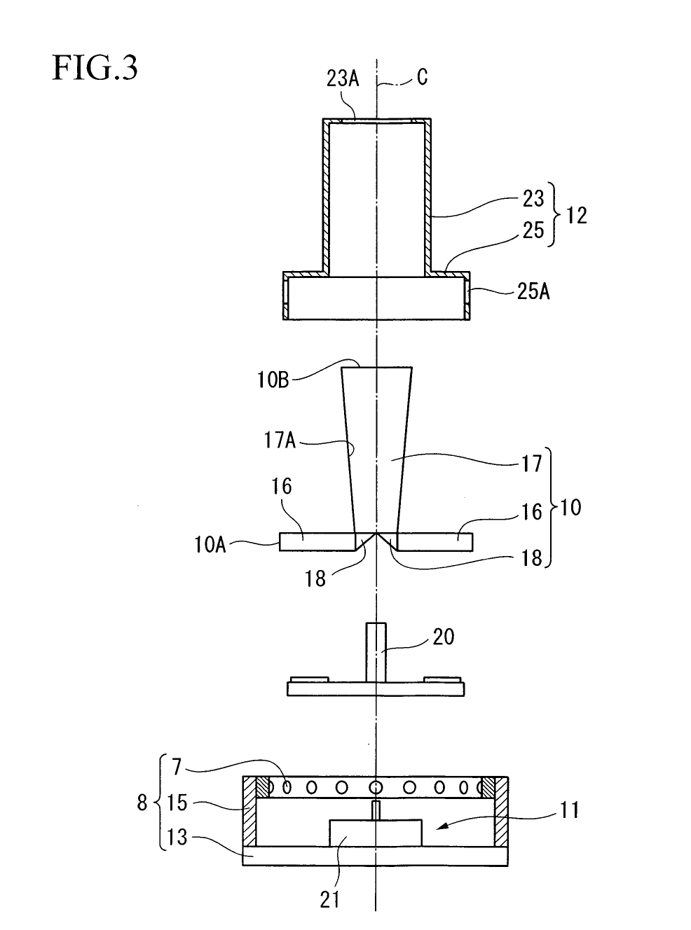

As shown in FIG. 2 and FIG. 3, the light emitting apparatus 2A is provided with a light source unit 8 having a plurality of LEDs (light source portion) 7 which are arranged on a circumference of a circle, and emit light, a light leading unit 10 which has a light entering end 10A into which the light emitted by LEDs 7 is entered, and a light emitting end 10B into which the light which are sent from the light entering end 10A are entered, the light is reflected by a inner surface thereof, and the light which is transmitted is emitted therefrom, a driving unit 11 for rotating the light leading unit 10 around a rotation axis C which passes through a center of the circumference of the circle at which the LEDs 7 are arranged, and is made orthogonal to a surface including the circumference of the circle, and a rod cover (a cover portion) 12 which covers at least a part of the light leading unit 10, and decreases a reaction which is given from a surrounding atmosphere according to a rotation of the light leading unit 10.

A light source unit 8 is provided with a holder portion 15 which is formed at a circular shape, and is connected on a base 13, and a plurality of LEDs 7 are arranged in an inner circumference surface of the holder portion 15 so that a side of a light emitting surface faces to a center portion of the holder portion 15.

The light leading unit 10 is provided with two horizontal rods 16 of which a light entering end 10A is arranged while being opposited to the LEDs 7, are arranged at position which is rotationally symmetrical with each other with regard to a rotation axis C, and are formed as angular column shapes, a perpendicular rod 17 which stands along the rotation axis C, has a reflection surface 17A which reflects the entirety of the light which is entered from the light entering end 10A by an inner surface, and the above-mentioned light emitting end 10B, and are formed as an angular column shape, a bending prism 18 which is connected to the horizontal rods 16, and changes the direction of the light entered from the light entering end 10A toward the side of the perpendicular rod 17.

The driving unit 11 is provided with a rod holder 20 which supports the light leading unit 10 and the rod cover 12, a rotation motor 21 which rotates the light leading unit 10 via the rod holder 20, and a motor rotation control circuit 22 which controls the rotation of the rotation motor 21.

The rod cover 12 is provided with a first cover 23 which has an opening portion 23A for the light emitting end 10B of the perpendicular rod 17, and covers the entirety of the perpendicular rod 17 other than the light emitting end 10B, and a second cover 25 which has an opening portion 25A for the light entering end 10A of the horizontal rods 16, and covers the entirety of the horizontal rods 16 other than the bending prism 18 and the light entering end 10A.

The first cover 23 is connected to the second cover 25 along the rotation axis C, and the second cover 25 is connected to the rod holder 20, and can rotate with the light leading unit 10. Each cover 23 and 25 is formed to a cylindrical shape, and has a shape by which the reaction is decreased, compared with a surface of the angular column shape of the light leading unit 10. Moreover, the extent of the moment of inertia of the rod cover 12 is smaller than the moment according to the reaction of the light leading unit 10 which is decreased by the rod cover 12. Each opening portion 23A and 25A is formed so that each opening portion 23A and 25A is slightly larger than the light entering end 10A or the light emitting end 10B, and thereby each opening portion 23A and 25A does not touch the light entering end 10A or the light emitting end 10B.

The space modulation unit 3A is provided with a LED panel 26, and is connected to an image display control circuit 27 which outputs an image modulation signal.

A total control circuit 6 performs input and output of the information of the number of rotations of the rotation motor 21 with the motor rotation control circuit 22, while the total control circuit 6 outputs the LED lighting signal to LEDs 7 while synchronizing the rotation of the rotation motor 21.

Next, operation methods, function, and effect of the projector 1 and the light emitting apparatus 2A according to the present embodiment are explained.

First, the rod holder 20 is rotated by driving the rotation motor 21, and both the light leading unit 10 and the rod cover 12 are rotated (thereinafter, the light leading unit 10 and the rod cover 12 are called a rotation portion).

Here, when the moment of inertia in the case of having only the light leading unit 10, not having the rod cover 12 is M, the moment of inertia of the entirety of the rotation member which is added by the rod cover 12 according to the present embodiment is m1, the moment of inertia of the rod cover having a larger moment of inertia than m1 is m2, the starting torque of the rotation motor 21 is T, the predetermined number of rotations of the rotation portion is ωc, regarding the conventional case in which the rod cover 12 is not provided, the case according to the present embodiment in which the rod cover 12 is equipped, and the case in which the rod cover which has the larger moment of inertia than the above case is equipped, the time (starting time) untill the number of rotations of the rotation motor 21 becomes ωc is compared, and thereby the function of the light emitting apparatus 2A according to the present embodiment is explained.

When not having the rod cover 12, in the beginning of starting of the rotation, the number of rotations increases by inclination of T/M.

However, because the reaction which is given from the surrounding atmosphere according to the increase of the number of rotations increases, an increase rate of the number of rotations decreases.

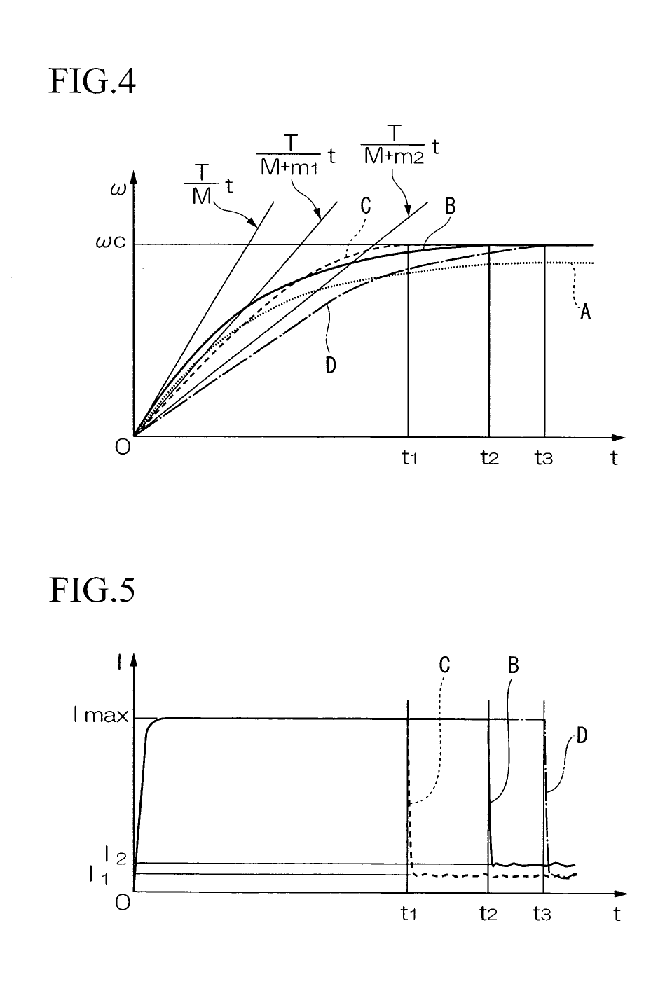

Furthermore, because an air pressure which affects the rotation portion is large, the rotation motor enters a regular rotation state without reaching ωc (A in FIG. 4).

When the rod cover 12 does not exist, and the air pressure is smaller than in the case of A, the rotation motor can reach ωc; however, because time is taken because of the air pressure, the rotation motor reaches ωc after t2 from starting (B in FIG. 4).

On the other hand, when the rod cover 12 according to the present embodiment of the moment of inertia m1 is attached, in the beginning of starting of the rotation, the number of rotations increases by inclination of T/(M+m1). However, because the moment of inertia increases at m1, compared with in the case of not having the rod cover 12, the increase rate of the number of rotations is lower than the conventional case. However, because, in the case in which the number of rotations becomes high, force due to the surrounding atmosphere is smaller than in the case of not having the rod cover 12, change of the increase rate of the number of rotations is small. Therefore, in spite of the increase in the moment of inertia, the time t1 for reaching the predetermined number of rotations is shorter than the time (t2) in the case of not having the rod cover 12 (C in FIG. 4).

However, when the moment of inertia of the rod cover is not less than the predetermined value (for example, m2), the influence by the increase of the moment of inertia is larger than the influence by the decrease of the reaction due to the rod cover, the time t3 for reaching ωc is longer than in the case of not having the rod cover 12 (D in FIG. 4).

Moreover, the value of the electrical current consumed by the motor in the regular rotation state which is required for driving of the rotation motor 21 reaches the maximum electrical current value (Imax), once, and decreases to the value of the electrical current for maintaining the regular rotation. When the rod cover 12 according to the present embodiment is equipped, after the time t1 passes, the value of the electrical current decreases to I1 (C in FIG. 5). On the other hand, when the rod cover 12 is not equipped, the value of the electrical current after the time t2 has passed decreases to only I2 (B in FIG. 5). In addition, when the rod cover of the moment of inertia m2 is equipped, the value of the electric current after the time t3 passes decreases to I1 which is the same value with the present embodiment (D in FIG. 5).

Thus, after the rotation portion enters into the regular rotation, for example, the rotation quantity of the rod holder 20 is monitored, the rotation signal which is monitored is transmitted to the motor rotation control circuit 22, and further, the total control circuit 6 controls the emitting timing of the LEDs 7, and the only LED 7 opposite to the light entering end 10A of the horizontal rods 16 performs the pulse emitting. Furthermore, the LEDs 7 arranged at the holder portion 15 are successively emitted in succession according to the rotation of the light leading unit 10, and thereby a high luminance of light is effectively taken out in succession from the light emitting end 10B of the perpendicular rod 17 without emitting of all LEDs 7 in succession.

Furthermore, when dispersion of quantity of light of the LEDs 7 is generated, the electric current for driving the LEDs 7 is performed the feedback control based on the signal which is monitored so that the quantity of light is optimized, and the uniform light is emitted. The motor rotation control circuit 22 controls the number of rotations of the rotation motor 21 so that the number of rotations of the rotation motor 21 is maintained at a constant number of rotations.

The high luminance and high parallelity of light obtained by the above way is supplied to the LCD panel 26.

Furthermore, the other light emitting apparatuses 2B and 2C, and the other space modulation units 3B and 3C are operated by the same method as the above method, and thereby the image which is outputted adjusting each color of red, blue, and green is projected on the screen or on the write board which is not shown, by using the projection lens 5.

According to the light emitting apparatus 2A, when the light leading unit 10 is rotated, the rod cover 12 is rotated with the light leading unit 10, and thereby the force which is generated between the light leading unit 10 and the surrounding atmosphere by the rotation can be decreased by using the rod cover 12. Therefore, even if the conventional rotation driving power is applied, the light leading unit 10 can be rotated by the lower power than in the case of rotating by only the light leading unit 10.

Moreover, when the rod cover 12 and the light leading unit 10 are rotated, even if the moment of inertia of the rod cover 12 is increased, the moment according to the reaction can be decreased more than the above, the time untill the light leading unit 10 reaches to the predetermined number of rotations can be shortened, compared with the time in the case of not having the rod cover 12. Furthermore, the value of the electric current for driving which is required for the rotation motor 21 when reaching the predetermined number of rotations can be decreased.

Furthermore, according to the projector 1 in the present embodiment, because the light emitting apparatus 2A is provided, the starting time from the boot state to the ready state of the projector 1 can be shortened. Moreover, the energy consumption when the regular driving is performed can be reduced, and the energy saving of the entirety of projector 1 can be carried out.

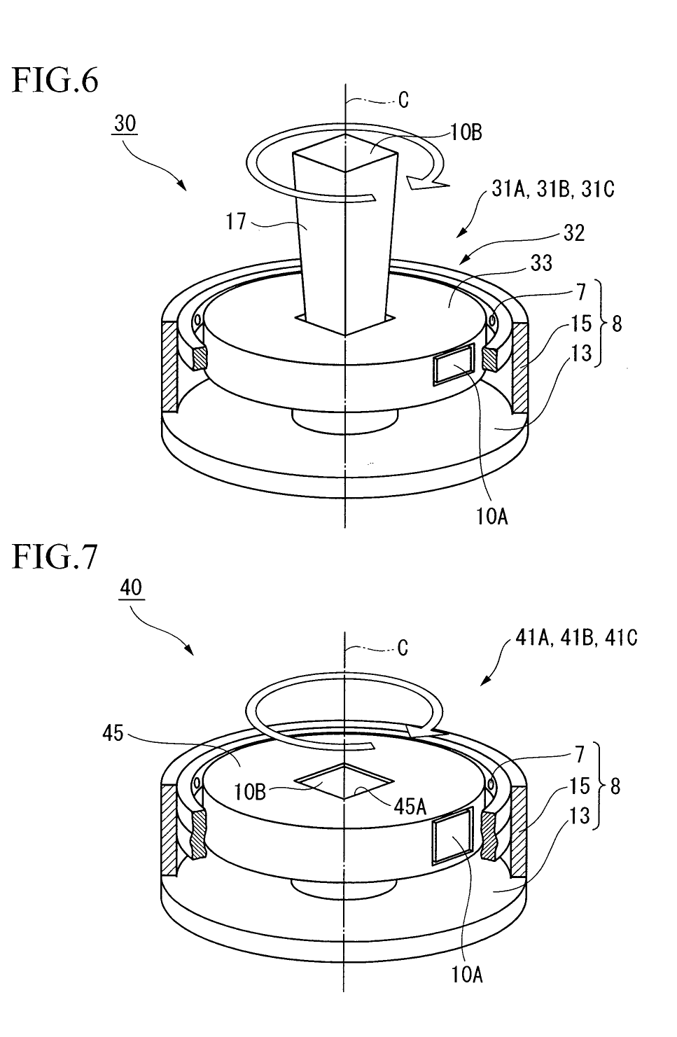

Next, the second embodiment is explained with reference to FIG. 6.

In addition, the same symbols are attached to the same components as in the first embodiment, and the explanations of the same components as in the first embodiment are omitted.

A different feature between the second embodiment and the first embodiment is that the rod cover 32 according to the light emitting apparatus 31A, 31B, and 31C of the projector 30 in the present embodiment is provided with only the second cover 33 which covers the horizontal rod 16 of which rotation peripheral speed is high.

The peripheral speed of the perpendicular rod 17 with a small rotation radius from the rotation axis C when rotating is comparatively small. In contrast to this, because the horizontal rod 16 extends to the direction of the rotation radius, the peripheral speed in the light entering end 10A when rotating is large. Therefore, the reaction which affects the horizontal rod 16 becomes larger than the reaction which affects the perpendicular rod 17.

Then, according to the light emitting apparatus 31A, 31B, and 31C in the present embodiment, the rod cover 32 has only the second cover 33, thereby the moment of inertia according to the first cover 23 can be decreased, the increase of the moment of inertia of the rod cover 32 is suppressed, and the reaction when rotating the light leading unit 10 can be efficiently suppressed by the same function as in the first embodiment.

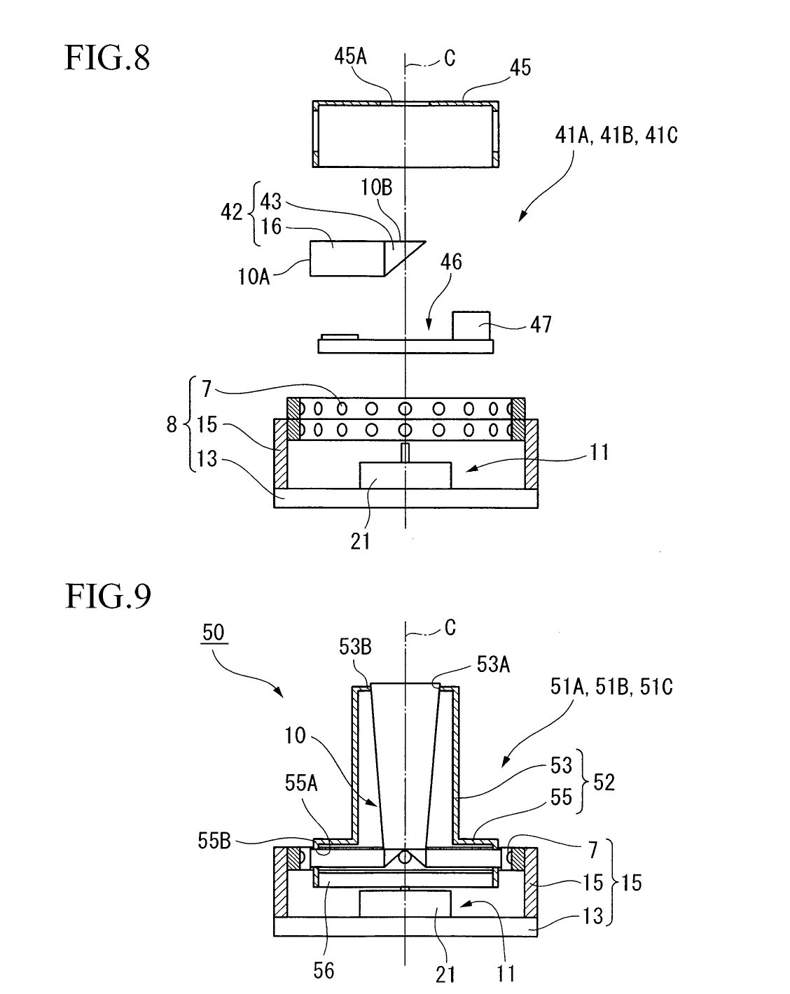

Next, the third embodiment is explained with reference to FIG. 7 and FIG. 8.

In addition, the same symbols are attached to the same components as in the other embodiment, and the explanations of the same components as in the other embodiment are omitted.

A different feature between the third embodiment and the second embodiment is that the light leading unit 42 according to the light emitting apparatus 41A, 41B, and 41C of the projector 40 in the present embodiment is provided with one horizontal rod 16 and a bending prism 43, and the light emitting end 10B is arranged at the bending prism 43.

The opening portion 45A for the light emitting end 10B is arranged at the second cover 45. Moreover, on the rod holder 46, balance weight of the light leading unit 42 is arranged at position which is rotationally symmetrical to the light entering end 10A with regard to the rotation axis.

According to the light emitting apparatuses 41A, 41B, and 41C, even if the light leading unit 42 has only one light entering end 10A, not having the perpendicular rod 17, because the balance weight is arranged, the light leading unit 42 can be stably rotated. Furthermore, the third embodiment can obtain the same function and effect as the second embodiment.

Next, the fourth embodiment is explained with reference to FIG. 9.

In addition, the same symbols are attached to the same components as in the other embodiment which is mentioned above, and the explanations of the same components as in the other embodiment are omitted.

A different feature between the fourth embodiment and the first embodiment is that the light leading unit 10 according to the light emitting apparatus 51A, 51B, and 51C of the projector 50 in the present embodiment is supported by only the rod cover 52.

A taper rod supporting portion 53B which supports the perpendicular rod 17 by contacting with the reflection surface near the light emitting end 10B of the perpendicular rod 17 is arranged at the opening portion 53A for the light emitting end 10B of the first cover 53.

Moreover, a parallel rod supporting portion 55B which supports the horizontal rod 16 by contacting with the side surface near the light entering end 10A of the horizontal rod 16 is arranged at the opening portion 55A for the light entering end 10A of the second cover 55. Furthermore, the rod holder 56 is formed as a disc shape, and engaged with the second cover 55. Because of such a constitution, when the rod cover 52 is rotated, the light leading unit 10 can be rotated.

According to the light emitting apparatuses 51A, 51B, and 51C, the rod holder 56 need not support the light leading unit 10, and the shape of each opening portion 53A and 55A of the rod cover need not be largely changed, and the light leading unit 10 can be supported, thereby the rod holder 56 can be light in weight, and the moment of inertia due to the rotation can be decreased, compared with in the case of the first embodiment.

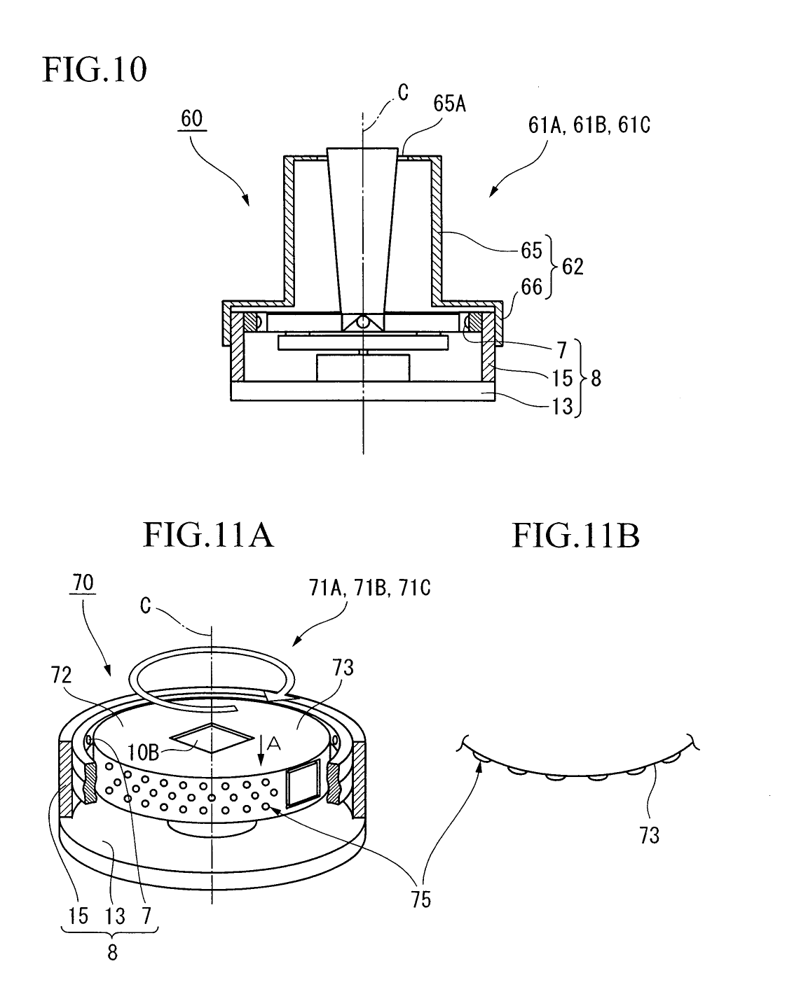

Next, the fifth embodiment is explained with reference to FIG. 10.

In addition, the same symbol is attached to the same composition as the other embodiment which is mentioned above, and the explanation of the same composition as the other embodiment is abbreviated.

A different feature between the fifth embodiment and the fourth embodiment is that the rod cover 62 according to the light emitting apparatuses 61A, 61B, and 61C of the projector 60 in the present embodiment is connected and fixed to the light source unit 8, not to the driving unit 11, and the rod cover 62 and the light leading unit 10 are adjacent to each other with a gap.

Most of the end surface at the side of the light emitting end 10B according to the first cover 65 is the opening portion 65A, and the inside diameter of the entirety of cover is the almost same size with a virtual circular diameter which contacts with the outside of the light emitting end 10B of the perpendicular end 17.

The second cover 66 is adjacent to the side surface of the horizontal rod 16 with a slight gap, and the inner diameter of the cover is the size so that the cover can engaged with the holder portion 15.

According to the light emitting apparatuses 61A, 61B, and 61C, because, even if the light leading unit 10 rotates, the rod cover 62 does not rotate, the moment of inertia due to the rotation can be the extent by only the light leading unit 10, and thereby the light leading unit 10 can be easily rotated.

Moreover, because the gap between the rod cover 62 and the light leading unit 10 is small, the air within the gap can be rotated by the rotation of the light leading unit 10. Therefore, even if the light leading unit 10 rotates, exfoliation of the surrounding atmosphere from the surface of the light leading unit 10 can be suppressed, and thereby the reaction at the time of rotating can be decreased.

Next, the sixth embodiment is explained with reference to FIG. 11A and FIG. 11B.

In addition, the same symbol is attached to the same composition as the other embodiment which is mentioned above, and the explanation of the same composition as the other embodiment is abbreviated.

A different feature between the sixth embodiment and the third embodiment is that a plurality of convex portions 75 are arranged on the surface at the side of cylindrical surface in the second cover 73 of the rod cover 72 according to the light emitting apparatus 71A, 71B, and 71C of the projector 70 in the present embodiment.

When the second cover 73 rotates, the plurality of convex portions 75 is set at the predetermined size and height, and thereby the second cover 73 functions as a vortex generator which suppresses exfoliation of a boundary layer. Therefore, desirable size of vortexes occur in desirable intervals above the surface of the second cover 73 according to the rotation speed of the second cover 73.

According to the light emitting apparatuses 71A, 71B, and 71C, exfoliation on the surface of the rod cover 72 can be suppressed, the flow of air can be made smooth, and the reaction can be decreased.

In the sixth embodiment, although the convex portions 75 are formed at the cylindrical surface of the second cover 73, the convex portions 75 are formed at the side surface at the side of the opening portion, and are formed at both the surface of the first cover and the surface of the second cover which are provided at the rod cover according to the other embodiment.

Moreover, recess portions, not the convex portions can function as the vortex generator, and further, both the convex portions and the recess portions may be formed.

According to the light emitting apparatus in the present invention, when the light leading unit is rotated, the reaction occurring between the light leading unit and the surrounding atmosphere by the rotation can be decreased by using the cover portion, and thereby even if the conventional rotation driving power is applied, the light leading unit can be easily rotated.

According to the present invention, the time for reaching the predetermined number of rotations of the light leading unit can be decreased, compared with the conventional case.

Moreover, the energy which is necessary for a driving unit in order to rotate the light leading unit can be decreased.

Moreover, according to the light emitting apparatus in the present invention, a surface of the cover portion has a shape by which the reaction is decreased, compared with a surface of the light leading unit, and the cover portion is rotated with the light leading unit.

In the present light emitting apparatus, by rotating the cover portion with the light leading unit, the reaction which is given to the light leading unit can be decreased, and the light leading unit can be rotated by a lower power than in the case of rotating only the light leading unit.

Moreover, according to the light emitting apparatus in the present invention, the light leading unit is supported by the cover portion.

In the present light emitting apparatus, the light leading unit can be rotated by rotating the cover portion.

Therefore, the member which supports the light leading unit to the driving unit need not be arranged, and to that extent, the moment of inertia for the rotation part can be decreased.

Moreover, according to the light emitting apparatus in the present invention, the cover portion is connected to the light source unit.

In the present light emitting apparatus, because the cover portion does not rotate, the moment of inertia due to the rotation can be determined by only the size of the light leading unit, and thereby the light leading unit can be easily rotated.

Moreover, according to the light emitting apparatus in the present invention, the cover portion and the light leading unit are adjacent to each other with a gap.

In the present light emitting apparatus, the air in the gap between the cover portion and the light leading unit can be rotated with the rotation of the light leading unit, abrasion of the surrounding atmosphere by the rotation of the light leading unit can be suppressed, and the air pressure can be decreased.

Moreover, according to the light emitting apparatus in the present invention, a plurality of light entering end of the light leading unit are arranged at position which is rotationally symmetrical with each other with regard to the rotation axis, and the light emitting end of the light leading unit is arranged near the rotation axis.

In the present light emitting apparatus, by rotating the light leading unit, the light can be entered from the light source unit which is arranged on the circumference of the circle to a plurality of light entering ends, respectively, and the light can be emitted from the light emitting end while condensing the light.

Moreover, because the light entering ends are arranged to rotationally symmetrical, the light leading unit can be stably rotated.

Moreover, according to the light emitting apparatus in the present invention, one light entering end of the light leading unit is arranged, and balance weight of the light leading unit is arranged at a position which is rotationally symmetrical to the light entering end with regard to the rotation axis.

In the present light emitting apparatus, even if the light entering end is one, because a balance weight is arranged, the light leading unit can be stably rotated.

Moreover, in the light emitting apparatus according to the present invention, the driving unit rotates the light leading unit until the light leading unit reaches at the predetermined number of the rotations while accelerating the light leading unit, a value of integrating and adding an acceleration of the light leading unit which increases by the decrement of the reaction is larger than a value of integrating and adding an acceleration of the light leading unit which decreases by the moment of inertia of the cover portion during a time from a start to reaching the predetermined number of rotations.

In the present light emitting apparatus, when the cover portion and the light leading unit are rotated, the moment of inertia of the rotation part increases by the cover portion, even if angular acceleration of the rotation decreases, the moment due to the reaction which occurs by the rotation can be decreased more than the above, the time untill the light leading unit reaches to the predetermined number of rotations can be shortened, compared with in the case of not having the cover portion.

Moreover, the light emitting apparatus according to the present invention, at least one part of a plurality of convex portions and a plurality of recess portions are arranged on a surface of the cover portion.

In the present light emitting apparatus, when the cover portion is rotated, at least one part of a plurality of convex portions and a plurality of recess portions function as the vortex generator, and thereby small size of vortexes can be formed in boundary layer on the surface of the cover portion.

Therefore, exfoliation on the surface of the cover portion can be suppressed, the flow of air can be made smooth, and the reaction can be decreased.

An image projection apparatus according to the present invention projects an image based on an inputted data using the above-mentioned light emitting apparatus, and has a space modulation unit which modulates the light emitted from the light emitting end of the light leading unit based on the inputted data, and a projection optical unit which projects the light modulated by the space modulation unit.

According to the image projection apparatus, because the light emitting apparatus according to the present invention is equipped, the starting time from the boot state to the ready state of the image projection apparatus can be shortened.

Moreover, the energy consumption when the regular driving of the driving unit is performed can be reduced, and the energy saving of the entirety of projector can be carried out.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A light emitting apparatus comprising:
a light source unit having a light source portion which is arranged on a circumference of a circle, and emits light;
a light leading unit which has a light entering end into which the light emitted by the light source unit is entered, and a light emitting end from which the light, which is sent from the light entering end and is reflected by an inner surface, is emitted;
a driving unit for rotating the light leading unit around a rotation axis which passes through a center of the circumference of the circle, and is made orthogonal to a surface including the circumference of the circle; and
a cover portion which covers at least a part of the light leading unit, and decreases a reaction which is given from a surrounding atmosphere according to a rotation of the light leading unit.

2. A light emitting apparatus according to claim 1,
wherein a surface of the cover portion has a shape by which the reaction is decreased, compared with a surface of the light leading unit, and the cover portion is rotated with the light leading unit.

3. A light emitting apparatus according to claim 2,
wherein the light leading unit is supported by the cover portion.

4. A light emitting apparatus according to claim 1,
wherein the cover portion is connected to the light source unit.

5. A light emitting apparatus according to claim 4,
wherein the cover portion and the light leading unit are adjacent to each other with a gap.

6. A light emitting apparatus according to claim 1,
wherein a plurality of light entering ends of the light leading unit are arranged at position which is rotationally symmetrical with each other with regard to the rotation axis, and the light emitting end of the light leading unit is arranged near the rotation axis.

7. A light emitting apparatus according to claim 1,
wherein one light entering end of the light leading unit is arranged, and balance weight of the light leading unit is arranged at a position which is rotationally symmetrical to the light entering end with regard to the rotation axis.

8. A light emitting apparatus according to claim 2,
wherein the driving unit rotates the light leading unit until the light leading unit reaches at the predetermined number of rotations while accelerating the light leading unit, a value of integrating and adding an acceleration of the light leading unit which increases by the decrement of the reaction is larger than a value of integrating and adding an acceleration of the light leading unit which decreases by the moment of inertia of the cover portion during a time from a start to reaching the predetermined number of rotations.

9. A light emitting apparatus according to claim 1,
wherein at least one part of a plurality of convex portions and a plurality of recess portions are arranged on a surface of the cover portion.

10. An image projection apparatus which projects an image based on an inputted data using the light emitting apparatus according to claim 1, comprising:
a space modulation unit which modulates the light emitted from the light emitting end of the light leading unit based on the inputted data; and
a projection optical unit which projects the light modulated by the space modulation unit.
